(19) United States
(12) Patent Application Publication
(10) Pub. No.: US 2005/0134576 A1
(43) Pub. Date: Jun. 23, 2005

(54) Handheld electronic device with touch control input module

(75) Inventors: Jao-Ching Lin, Hsin-Chuang City (TW); Shyh-In Hwang, Hsin-Chuang City (TW); Lin Chu, Hsin-Chuang City (TW); Chung-Yi Shen, Hsin-Chuang City (TW)

Correspondence Address: BRINKS HOFER GILSON & LIONE;NBC Tower, Suite 3600, 455 N. Cityfront Plaza Drive, Chicago, IL, 60611-5599, US

(73) Assignee: Sentelic Corporation

(21) Appl. No.: 10/796,607

(22) Filed: Mar. 9, 2004

(30) Foreign Application Priority Data
Dec. 19, 2003 (CN) 200310121523.3

(51) Int. Cl. G09G 5/00

(52) U.S. Cl. 345/173

(57) ABSTRACT

A handheld electronic device includes a touch control input module and a processing device. The touch control input module includes a protective layer, a sensing layer, and a signal processing unit. The protective layer has outer and inner surfaces. The outer surface is defined with a plurality of contact regions, each of which is marked with a symbol. The sensing layer is in contact with the inner surface, and is responsive to contact of an object with the outer surface so as to generate an electrical output indicative of contact position of the object with the outer surface. The signal processing unit receives the electrical output, and generates a control output corresponding thereto. The processing device is responsive to the control output from the signal processing unit so as to perform an operation associated with the control output.

### CROSS-REFERENCE TO RELATED APPLICATION

This application claims priority of Chinese Appln. No. 200310121523.3, filed on Dec. 19, 2003.

### BACKGROUND OF THE INVENTION

1. Field of the Invention

The invention relates to a handheld electronic device, more particularly to a handheld electronic device with a touch control input module.

2. Description of the Related Art

Most portable electronic products rely on a keyboard consisting of a plurality of keys as a primary data input medium. Although the manufacturing technologies of both keys and keyboards are quite mature, and the component costs thereof have considerably dropped over the years, the number of components needed for assembly is still rather large. As such, the entire structure remains relatively complicated, thus incurring high assembly costs. Accordingly, the effect of lowering production costs through simplification of production flow is limited. Besides, in the past, the low cost of individual components is achieved by mass production through mold techniques. However, current trends toward customization and personalization of electronic products require the fabrication of various components in different styles at relatively small quantities. Hence, manufacturing costs are not lowered when customized keys and keyboard devices are fabricated using mold techniques commonly used in mass production. Moreover, current electronic products, such as mobile phones, notebook computers, etc., are designed to meet consumer demands, such as lighter, thinner, shorter, smaller, etc. Due to the present trend toward miniaturization, providing electronic products with keys and keyboards as input modules will unavoidably incur higher manufacturing costs in view of the pursuit for accuracy and the difficulty in assembling miniaturized components. Accordingly, miniaturized electronic products with keys and keyboards tend to lose their competitive edge in the market.

On the other hand, since a touch control input module provides advantages, such as user-friendliness and small operating space requirement, a growing number of electronic products incorporate the touch control input module as an optional man-machine interface. Particularly, not only do current notebook computers include touch control pads, some mobile phones also incorporate touch control panels, which provide a handwriting function on their screens. Furthermore, handheld electronic devices, such as personal digital assistants (PDA), tablet personal computers, etc., include touch control screens that serve as primary data input/output modules.

However, the touch control pads on some electronic products, such as notebook computers, are designed primarily for a handwriting function, which involves generation of relative coordinates similar to those associated with a computer mouse. Particularly, input commands, such as those for controlling cursor movement, are interpreted according to distance and direction of consecutive user contact with the touch control pad. On the other hand, as the touch control screens of other electronic products, such as PDAs and tablet personal computers, serve as primary data input/output modules, many restrictions are encountered in view of the need to provide for both data input and output functions at the same time. For instance, the material for fabricating the touch control screen is limited to light-transmissible conductive glass, which not only mandates higher costs, but also suffers from inferior characteristics, such as durability, flexibility, etc. Furthermore, since data display through the touch control screen proceeds by way of image projection, there is a need to switch the operating mode of the touch control screen before the latter can act as a data input module. As such, data input through the touch control screen is both inconvenient and time-consuming. In addition, when the touch control screen is frequently used for data input, the battery power of the electronic product is quickly exhausted, and the service life of the touch control screen is shortened as well.

Moreover, since conductive glass is needed for fabrication, due to limitations of current manufacturing technology, the touch control screen can only be designed in the form of a rectangular flat plate, which precludes fabrication in other shapes, such as curved, circular, polygonal other than rectangular, etc. Therefore, the touch control screen is unsuitable for uniquely designed casings of electronic products, and is hence seldom applied to customized and miniaturized modern electronic products.

Furthermore, when the electronic device is primarily for input use, such as a remote controller, or is primarily for outputting non-visual information, such as portable radios, use of the aforesaid touch control screen having both input and output functions not only increases costs, but also introduces adverse affects to user convenience and durability of the electronic device.

### SUMMARY OF THE INVENTION

Therefore, the object of the present invention is to provide an electronic device with a touch control input module that can overcome the aforesaid drawbacks associated with the prior art.

According to one aspect of the present invention, there is provided a handheld electronic device that comprises a case body, a touch control input module, and a processing device. The touch control input module is mounted on the case body, and includes a protective layer, a sensing layer, and a signal processing unit. The protective layer has an outer surface exposed from the case body, and an inner surface opposite to the outer surface. The outer surface is defined with a plurality of contact regions, each of which is marked with a symbol. The sensing layer is in contact with the inner surface of the protective layer, and is responsive to contact of an object with the outer surface of the protective layer so as to generate an electrical output indicative of contact position of the object with the outer surface of the protective layer. The signal processing unit is coupled electrically to the sensing layer for receiving the electrical output and for generating a control output corresponding to the electrical output. The processing device is disposed in the case body, is coupled electrically to the signal processing unit, and is responsive to the control output from the signal processing unit so as to perform an operation associated with the control output.

According to another aspect of the present invention, there is provided a touch control input module that includes a protective layer, a sensing layer, and a signal processing unit. The protective layer has opposite outer and inner surfaces. The outer surface is defined with a plurality of contact regions, each of which is marked with a symbol. The sensing layer is in contact with the inner surface of the protective layer, and is responsive to contact of an object with the outer surface of the protective layer so as to generate an electrical output indicative of contact position of the object with the outer surface of the protective layer. The signal processing unit is coupled electrically to the sensing layer for receiving the electrical output and for generating a control output corresponding to the electrical output.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the first preferred embodiment of a handheld electronic device according to the present invention;

FIG. 2 illustrates a touch control input module of the first preferred embodiment; and

FIG. 3 is a schematic view of the second preferred embodiment of a handheld electronic device according to the present invention.

### DETAILED DESCRIPTION OF THE PREFERRED EMBODIMENTS

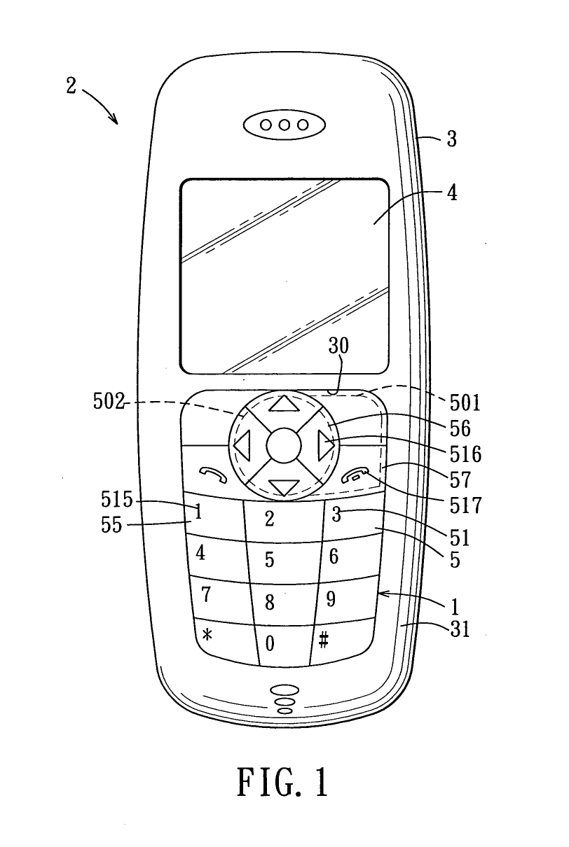

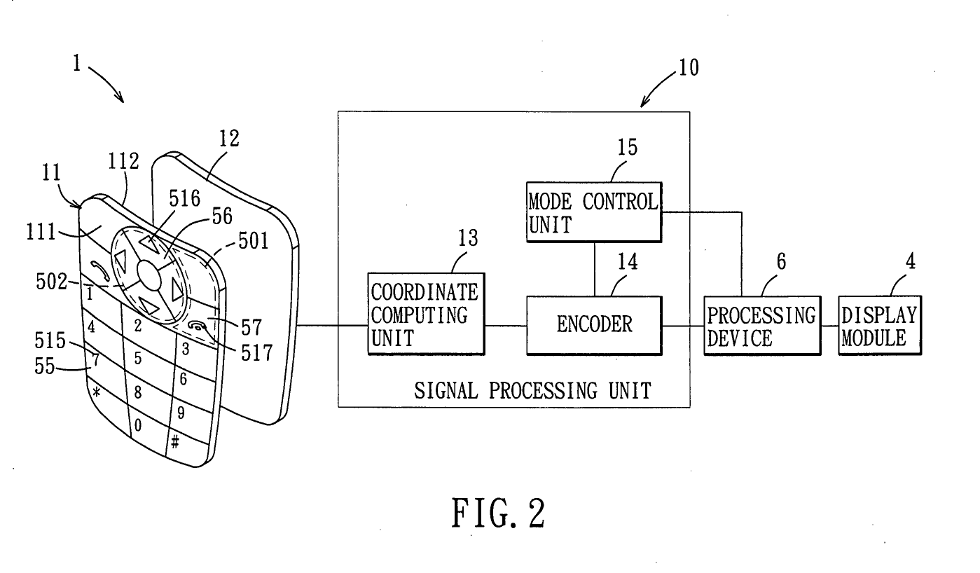

As shown in FIGS. 1 and 2, the first preferred embodiment of a handheld electronic device 2 according to the present invention is shown to be embodied in a mobile phone, and includes a case body 3 with a curved surface 31, a touch control input module 1 mounted on the case body 3, a display module 4 mounted on the case body 3, and a processing device 6 coupled electrically to the touch control input module land the display module 4, and disposed in the case body 3. The case body 3 is further formed with a recessed area 30 in the curved surface 31.

The touch control input module 1 includes a protective layer 11, a sensing layer 12, and a signal processing unit 10.

The protective layer 11 is disposed in the recessed area 30 in the curved surface 31 of the case body 3, and has an outer surface 111 exposed from the curved surface 31 of the case body 3, and an inner surface 112 opposite to the outer surface 111. The outer surface 111 is defined with a plurality of contact regions 5, each of which is marked with a symbol 51. In this embodiment, the protective layer 11 is made of a flexible plastic material, and the outer surface 111 is a curved surface so as to complement the curved surface 31 of the case body 3. However, it should be noted herein that the outer surface 111 need not necessarily be a curved surface, and can be in the form of a flat surface to suit a flat surface of a case body.

In this embodiment, the contact regions 5 provide the electronic device 2 with the functions of a telephone keypad, and are grouped into a numerical block 55, a directional block 56 and a functional block 57. The contact regions 5 in the numerical block 55 are marked with mutually distinct numerical symbols 515. The contact regions 5 in the directional block 56 are marked with mutually distinct arrow symbols 516. Some of the contact regions 5 in the functional block 57 are marked with distinct handset symbols 517 (i.e., a handset on-hook symbol and a handset off-hook symbol). In this embodiment, the contact regions 5 and the symbols 51 are printed on the outer surface 111 through an intaglio printing technique using a paint material that contains a phosphorescent material. However, printing of the same on the outer surface 111 may be conducted through other printing techniques, such as lithographic and relief printing. Moreover, the paint material maybe mixed with a fluorescent material, or may be one whose color characteristics vary according to the ambient light or the ambient temperature condition for enhancing visual appeal.

In this embodiment, the contact regions 5 and the symbols 51, which are printed on the outer surface 111 through an intaglio printing technique, project from the outer surface 111 of the protective layer 11. However, depending on the material of the protective layer 11, other methods, such as thermal press-forming and laser cutting, are available for forming the contact regions 5 and the symbols 51 that project from the outer surface 111. In other embodiments, the same methods are applicable to engrave the contact regions 5 and the symbols 51 in the outer surface 111 of the protective layer 11.

The sensing layer 12 is in contact with the inner surface 112 of the protective layer 11, and is responsive to contact of an object (not shown) with the outer surface 111 of the protective layer 11 so as to generate an analog electrical output indicative of contact position of the object with the outer surface 111 of the protective layer 11 in a conventional manner. In this embodiment, the sensing layer 12 is a capacitive-type sensing layer, and senses a contact position of the object with the outer surface 111 of the protective layer 11 through a feed current that is generated as a result of variation in capacitance when static electricity of the object couples with an electrode array. It should be noted herein that other types of sensing layers 12, such as resistive or electromagnetic, are also applicable to the present invention. Since the main technical feature of this invention does not reside in the specific configuration and operation of the sensing layer 12, which are well known to those skilled in the art, further details are omitted herein for the sake of brevity.

The signal processing unit 10 is coupled electrically to the sensing layer 12 for receiving the electrical output and for generating a control output corresponding to the electrical output. In this embodiment, the signal processing unit 10 includes a coordinate computing unit 13, an encoder 14, and a mode control unit 15.

The coordinate computing unit 13 is coupled electrically to the sensing layer 11 for receiving the electrical output and for generating a coordinate output corresponding to the electrical output. The encoder 14 is coupled electrically to the coordinate computing unit 13 for receiving the coordinate output and for generating the control output that corresponds to the coordinate output. In this embodiment, the encoder 14 is operable in a selected one of a default key input mode, where the control output generated by the encoder 14 corresponds to the symbol 51 marked on the contact region 5 that is associated with the coordinate output from the coordinate computing unit 13, and a handwriting input mode, where the control output generated by the encoder 14 corresponds to movement of the object on the outer surface 111 of the protective layer 11. The mode control unit 15 is coupled electrically to the processing device 6 and the encoder 14, and is associated operably with the encoder 14 for enabling operation of the encoder 14 in the selected one of the key input mode and the handwriting input mode. In practice, the aforesaid coordinate computing unit 13, the encoder 14 and the mode control unit 15 can be incorporated into a single integrated circuit chip (not shown).

When it is intended to perform an operation, such as inputting a set of numerical digits, the user simply uses his finger to press the contact regions 5 marked with the selected numerical symbols 515 in the numerical block 55. Subsequently, the sensing layer 12 senses contact positions of the user's finger with the outer surface 111 of the protective layer 11, and generates analog electrical outputs corresponding to the sensed contact positions for reception by the coordinate computing unit 13. The coordinate computing unit 13 then calculates coordinate outputs based on the electrical outputs, and provides the coordinate outputs to the encoder 14. In response to the coordinate outputs, the encoder 14 generates control outputs that correspond to the selected numerical symbols 515. The processing device 6 receives and processes the control outputs, and subsequently performs an operation associated with the control outputs, such as controlling the display module 4 to display the selected numerical symbols 515 thereon.

When operation in the handwriting mode is intended, the user first presses a designated contact region 5 in the functional block 57 that is designated for the mode control function. The sensing layer 12 senses the contact position of the user's finger with the outer surface 111 of the protective layer 11, and generates the analog electrical output corresponding to the sensed contact position for reception by the coordinate computing unit 13. The coordinate computing unit 13 then calculates the coordinate output based on the electrical output, and provides the coordinate output to the encoder 14. In response to the coordinate output, the encoder 14 generates the control output that corresponds to the designated contact region 5. The processing device 6 receives and processes the control output, and subsequently issues a mode switch command to the mode control unit 15 so as to enable operation of the encoder 14 in the handwriting input mode. Thereafter, when the user writes over the contact regions 5 in the numerical block 55, the sensing layer 12 senses the contact positions of the user's finger with the outer surface 111 of the protective layer 11, and generates analog electrical outputs corresponding to the sensed contact positions for reception by the coordinate computing unit 13. The coordinate computing unit 13 then calculates the coordinate outputs based on the electrical outputs, and provides the coordinate outputs to the encoder 14. In response to the coordinate outputs, the encoder 14 generates continuous control outputs corresponding to movement of the user's finger on the outer surface 111 of the protective layer 11 for processing by the processing device 6. Finally, the aforesaid mode switching operation is repeated when it is intended to switch operation back to the key input mode.

Instead of designating a contact region 5 in the functional block 57 for mode switching control, the mode control unit 15 can be configured to switch operation of the encoder 14 between the key input and handwriting input modes automatically by detecting whether the coordinate outputs from the coordinate computing unit 13 indicate crossing of a predefined set of adjacent contact regions 5.

Furthermore, the outer surface 111 of the protective layer 11 may be configured with at least a designated block that contains at least an adjacent pair of the contact regions 5. In practice, the number of the designated blocks can vary according to actual design requirements. In this embodiment, the designated block is defined by an adjacent pair of the contact regions 5 in the functional block 57, is assigned to a scroll-up or scroll-down function, and is thus named as a scrolling block 501. The control output generated by the encoder 14 corresponds to the scrolling block 501 when successive ones of the coordinate outputs from the coordinate computing unit 13 within a predetermined time period indicate movement of an object from one of the contact regions 5 in the adjacent pair to the other of the contact regions 5 in the adjacent pair. The control output that corresponds to the scrolling block 501 is then interpreted by the processing device 6 as a scroll-up or scroll-down command.

In this embodiment, the predetermined time period is 1 second. Therefore, when the user uses his finger to touch the scrolling block 501, and slides his finger within the 1-second predetermined time period from one of the contact regions 5 in the scrolling block 501 to the other of the contact regions 5 in the scrolling block 501 in a direction away from the display module 4, the consecutive coordinate outputs generated through the sensing of the sensing layer 12 and the calculation of the coordinate computing unit 13 indicate such movement and are subsequently interpreted by the encoder 14 as a scroll-down control output to be received by the processing device 6 so as to control scrolling of names, numbers or messages shown on the display module 4. Scroll-up control of the display module 4 proceeds in a similar manner. However, when it is intended to issue a scroll-up control output to the processing device 6, the user slides his finger within the 1-second predetermined time period from one of the contact regions 5 in the scrolling block 501 to the other of the contact regions 5 in the scrolling block 501 in a direction toward the display module 4.

In a modified embodiment, the handheld electronic device 2 is provided with a multi-media playback function. When playing a movie or an animation, the contact region 5 marked with a right arrow symbol 516 in the directional block 56 is configured for a forward play function, whereas the contact region 5 marked with a left arrow symbol 516 in the directional block 56 is configured for a reverse play function. The outer surface 111 of the protective layer 11 is further configured with a playback block 502 that contains all of the contact regions 5 in the directional block 56. Therefore, when the user uses his finger to touch the playback block 502, and rotates his finger about the playback block 502 in a clockwise direction within the 1-second predetermined time period, the coordinate outputs generated through the sensing of the sensing layer 12 and the calculation of the coordinate computing unit 13 indicate such movement and are subsequently interpreted by the encoder 14 as a fast-forward control output to be received by the processing device 6 for activating a fast-forward operation of the latter.

In the same token, when the user uses his finger to touch the playback block 502, and rotates his finger about the playback block 502 in a counterclockwise direction within the 1-second predetermined time period, the coordinate outputs generated through the sensing of the sensing layer 12 and the calculation of the coordinate computing unit 13 indicate such movement and are subsequently interpreted by the encoder 14 as a fast-rewind control output to be received by the processing device 6 for activating a fast-rewind operation of the latter.

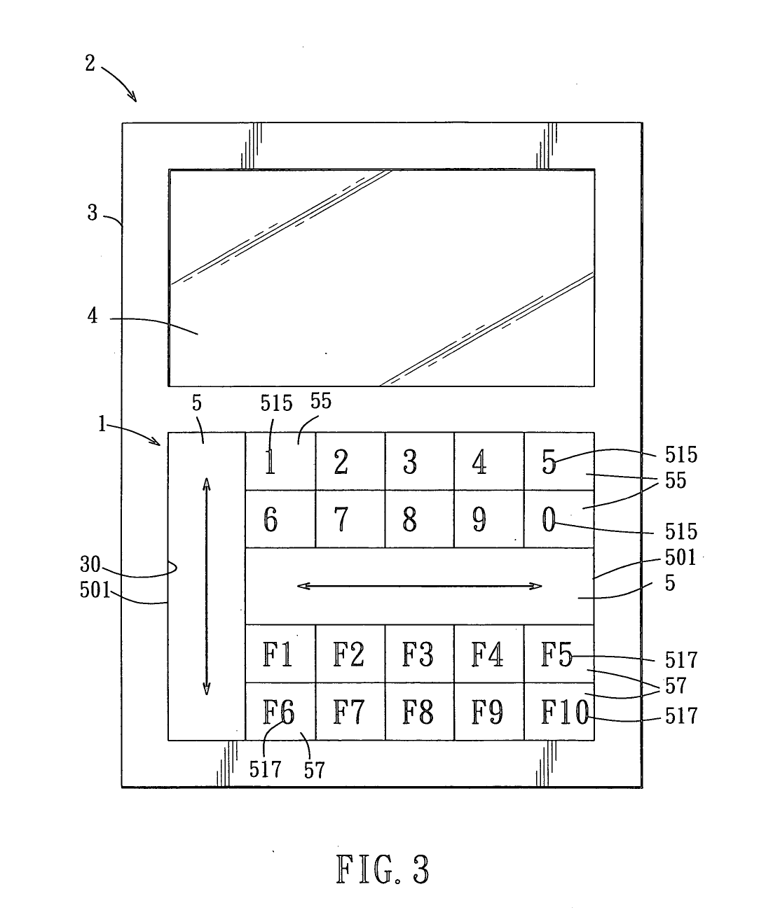

As shown in FIG. 3, the second preferred embodiment of a handheld electronic device 2 according to the present invention is shown to be embodied in a palm computer, which is designed for a special task, such as for use by policemen to verify license plates and personal identification, or for use by express delivery and cargo delivery personnel to facilitate delivery tracking and inventory control. The devices 2 of these types are available indifferent forms, and are required to bear frequent input activity for long periods of time.

The handheld electronic device 2 of this embodiment also includes a case body 3, a touch control input module 1 mounted on the case body 3, a display module 4 mounted on the case body 3, and a processing device (not shown) coupled electrically to the touch control input module 1 and the display module 4, and disposed in the case body 3. The case body 3 is also formed with a recessed area 30.

In this embodiment, the touch control input module 1 is substantially similar to that of the first preferred embodiment. To meet operating requirements, the contact regions 5 of the touch control input module 1 are likewise grouped into a numerical block 55 and a functional block 57. The contact regions 5 in the numerical block 55 are marked with mutually distinct numerical symbols 515. The contact regions 5 in the functional block 57 are marked with mutually distinct function symbols 517. Unlike the first preferred embodiment, the touch control input module 1 of this embodiment is further defined with a pair of scrolling blocks 501, each of which contains a distinct contact region 5. In this embodiment, the scrolling blocks 501 extend in mutually orthogonal directions, and are configured for left/right and up/down scrolling control, respectively. Therefore, when the user uses his finger to touch any one of the scrolling blocks 501, and drags his finger along the length of the distinct contact region 5 contained in the scrolling block 501 within the 1-second predetermined time period, the coordinate outputs generated through the sensing of the sensing layer 12 and the calculation of the coordinate computing unit 13 indicate such movement and are subsequently interpreted by the encoder 14 as a corresponding scrolling control output to be received by the processing device so as to enable the latter to perform the desired scrolling operation.

In sum, the handheld electronic device 2 of this invention uses the modularized touch control input module 1 that is manufactured using thin-membrane technology as a replacement for conventional keys and keyboards. Not only can manufacturing costs be reduced, production process is also simplified in view of automated manufacturing. Furthermore, this invention also fits the current marketing trend toward customization, and the thin-membrane technology also makes the handheld electronic device 2 lighter, thinner, shorter, smaller and more stylish, which are preferred by consumers nowadays.

Moreover, since the touch control input module 1 is dedicated for data input use, it is not restricted in terms of material for fabrication and shape of the case body. The possibility of adopting more durable and flexible materials also increases the competitive edge for this invention. In addition, there is no need for switching between data input and output modes as commonly encountered when conventional touch control screens are in use. The advantageous effects of this invention as compared to devices that incorporate conventional touch control screens are more evident when this invention is used outdoors.

In addition, when the electronic device is primarily for input use, such as a remote controller, or is primarily for outputting non-visual information, such as portable radios, use of the aforesaid touch control input module 1 not only results in lower costs, but also provides advantages in terms of user convenience and durability.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A handheld electronic device comprising:
a case body;
a touch control input module mounted on said case body and including
a protective layer having an outer surface exposed from said case body, and an inner surface opposite to said outer surface, said outer surface being defined with a plurality of contact regions, each of said contact regions being marked with a symbol,
a sensing layer in contact with said inner surface of said protective layer, said sensing layer being responsive to contact of an object with said outer surface of said protective layer so as to generate an electrical output indicative of contact position of the object with said outer surface of said protective layer, and
a signal processing unit coupled electrically to said sensing layer for receiving the electrical output and for generating a control output corresponding to the electrical output; and
a processing device disposed in said case body, coupled electrically to said signal processing unit, and responsive to the control output from said signal processing unit so as to perform an operation associated with the control output.

2. The handheld electronic device as claimed in claim 1, wherein said signal processing unit includes a coordinate computing unit coupled electrically to said sensing layer for receiving the electrical output and for generating a coordinate output corresponding to the electrical output, and an encoder coupled electrically to said coordinate computing unit for receiving the coordinate output and for generating the control output that corresponds to the coordinate output and that is provided to said processing device.

3. The handheld electronic device as claimed in claim 2, wherein said encoder is operable in a selected one of a key input mode, where the control output generated by said encoder corresponds to the symbol marked on said contact region that is associated with the coordinate output from said coordinate computing unit, and a handwriting input mode, where the control output generated by said encoder corresponds to movement of the object on said outer surface of said protective layer.

4. The handheld electronic device as claimed in claim 3, wherein said signal processing unit further includes a mode control unit associated operably with said encoder for enabling operation of said encoder in the selected one of the key input mode and the handwriting input mode.

5. The handheld electronic device as claimed in claim 3, wherein the symbols marked on said contact regions of said outer surface of said protective layer are distinct from each other.

6. The handheld electronic device as claimed in claim 2, wherein said outer surface of said protective layer is configured with a block that contains at least an adjacent pair of said contact regions, and the control output generated by said encoder corresponds to said block when successive ones of the coordinate outputs from said coordinate computing unit within a predetermined time period indicate movement of the object from one of said contact regions in said adjacent pair to the other of said contact regions in said adjacent pair.

7. The handheld electronic device as claimed in claim 2, wherein said outer surface of said protective layer is configured with a block that contains one of said contact regions, and the control output generated by said encoder corresponds to said block when successive ones of the coordinate outputs from said coordinate computing unit within a predetermined time period indicate movement of the object along a length of said one of said contact regions contained in said block.

8. The handheld electronic device as claimed in claim 1, wherein said outer surface of said protective layer is a flat surface.

9. The handheld electronic device as claimed in claim 1, wherein said outer surface of said protective layer is a curved surface.

10. The handheld electronic device as claimed in claim 1, wherein the symbols are printed on said contact regions using one of lithographic, relief and intaglio printing techniques.

11. The handheld electronic device as claimed in claim 10, wherein the symbols are printed on said contact regions using a paint material that contains one of a phosphorescent material and a fluorescent material.

12. The handheld electronic device as claimed in claim 1, wherein said contact regions are defined on said outer surface of said protective layer by printing using one of lithographic, relief and intaglio printing techniques.

13. The handheld electronic device as claimed in claim 12, wherein said contact regions are defined on said outer surface of said protective layer by printing using a paint material that contains one of a phosphorescent material and a fluorescent material.

14. The handheld electronic device as claimed in claim 1, wherein the symbols of said contact regions project from said outer surface of said protective layer.

15. The handheld electronic device as claimed in claim 1, wherein the symbols of said contact regions are engraved in said outer surface of said protective layer.

16. A touch control input module comprising:
a protective layer having opposite outer and inner surfaces, said outer surface being defined with a plurality of contact regions, each of said contact regions being marked with a symbol;
a sensing layer in contact with said inner surface of said protective layer, said sensing layer being responsive to contact of an object with said outer surface of said protective layer so as to generate an electrical output indicative of contact position of the object with said outer surface of said protective layer; and
a signal processing unit coupled electrically to said sensing layer for receiving the electrical output and for generating a control output corresponding to the electrical output.

17. The touch control input module as claimed in claim 16, wherein said signal processing unit includes a coordinate computing unit coupled electrically to said sensing layer for receiving the electrical output and for generating a coordinate output corresponding to the electrical output, and an encoder coupled electrically to said coordinate computing unit for receiving the coordinate output and for generating the control output that corresponds to the coordinate output.

18. The touch control input module as claimed in claim 17, wherein said encoder is operable in a selected one of a key input mode, where the control output generated by said encoder corresponds to the symbol marked on said contact region that is associated with the coordinate output from said coordinate computing unit, and a handwriting input mode, where the control output generated by said encoder corresponds to movement of the object on said outer surface of said protective layer.

19. The touch control input module as claimed in claim 18, wherein said signal processing unit further includes a mode control unit associated operably with said encoder for enabling operation of said encoder in the selected one of the key input mode and the handwriting input mode.

20. The touch control input module as claimed in claim 18, wherein the symbols marked on said contact regions of said outer surface of said protective layer are distinct from each other.

21. The touch control input module as claimed in claim 17, wherein said outer surface of said protective layer is configured with a block that contains at least an adjacent pair of said contact regions, and the control output generated by said encoder corresponds to said block when successive ones of the coordinate outputs from said coordinate computing unit within a predetermined time period indicate movement of the object from one of said contact regions in said adjacent pair to the other of said contact regions in said adjacent pair.

22. The touch control input module as claimed in claim 17, wherein said outer surface of said protective layer is configured with a block that contains one of said contact regions, and the control output generated by said encoder corresponds to said block when successive ones of the coordinate outputs from said coordinate computing unit within a predetermined time period indicate movement of the object along a length of said one of said contact regions contained in said block.

23. The touch control input module as claimed in claim 16, wherein said outer surface of said protective layer is a flat surface.

24. The touch control input module as claimed in claim 16, wherein said outer surface of said protective layer is a curved surface.

25. The touch control input module as claimed in claim 16, wherein the symbols are printed on said contact regions using one of lithographic, relief and intaglio printing techniques.

26. The touch control input module as claimed in claim 25, wherein the symbols are printed on said contact regions using a paint material that contains one of a phosphorescent material and a fluorescent material.

27. The touch control input module as claimed in claim 16, wherein said contact regions are defined on said outer surface of said protective layer by printing using one of lithographic, relief and intaglio printing techniques.

28. The touch control input module as claimed in claim 27, wherein said contact regions are defined on said outer surface of said protective layer by printing using a paint material that contains one of a phosphorescent material and a fluorescent material.

29. The touch control input module as claimed in claim 16, wherein the symbols of said contact regions project from said outer surface of said protective layer.

30. The touch control input module as claimed in claim 16, wherein the symbols of said contact regions are engraved in said outer surface of said protective layer.
